(19) United States
(12) Patent Application Publication
(10) Pub. No.: US 2020/0042758 A1
(43) Pub. Date: Feb. 6, 2020

(54) System and Method for the Automatic Reading of Optical, Machine-Readable Representations of Data

(71) Applicant: The Recon Group LLP, Miami, FL (US)

(72) Inventor: Sender Shamiss, Sunny Isles, FL (US)

(73) Assignee: The Recon Group LLP, Miami, FL (US)

(21) Appl. No.: 16/052,195

(22) Filed: Aug. 1, 2018

(51) Int. Cl. G06K 7/14; G06K 7/10

(52) U.S. Cl. CPC G06K 7/1413; G06K 7/10722

(57) ABSTRACT

The present disclosure is directed to a system and related methods of reading optical, machine-readable representations of data on the exterior surface of an article. A detection and imaging zone comprises a plurality of proximity sensors and a plurality of sets of high-speed, high-resolution imaging devices for reading representations of data on a still or moving article of arbitrary shape, size and orientation. The proximity sensors are configured for detecting the presence of an article in different locations in the detection and imaging zone, and the imaging devices are configured for imaging the exterior surface of the article. A processor is configured to converting images of an optical, machine-readable representation of data into data of a specified format, for example, strings of alphanumeric characters or other characters.

### FIELD OF THE INVENTION

The present disclosure relates to data recognition, and more particularly to systems and methods for the automatic reading of representations of data.

### BACKGROUND OF THE INVENTION

Universal product codes (UPCs) and other types of optical, machine-readable representations of data, for example quick-response (QR) codes, are ubiquitous means of encoding the identity of articles (e.g. consumer goods) and related data (e.g. product information). UPCs are common tools of inventory tracking and related processes. The encoded data can be read at multiple time points, for instance, distinct events in a product lifecycle (e.g. entry to and exit from a warehouse management system). Various technologies have been developed to read UPCs and other data representation formats. Despite their many advantages, these technologies also pose barriers to a more complete exploitation of UPCs and related representations of data.

Many common current approaches are limited by generally requiring a code-reading device, often called a ‘scanner’, to be brought into close proximity with a representation of data printed on or adhered to an article. The spatial orientation of the code-reading device relative to the representation of data is further limited to a narrow range of possibilities. Current readers of UPCs and related machine-readable representations of data thus pose significant barriers to process automation.

Scanning automation is potentially advantageous for many purposes, for example, increasing the rate of article processing in a warehouse. A typical automated data reading system will include an automated data reader. Examples of such readers are tunnel scanners and portal scanners. These devices can automatically scan items, for instance, items for sale in a retail store, or items to be tracked in inventory. An automated data reader can comprise one or more optical code readers, for example, laser scanners. The code readers can be configured and positioned around a “read zone,” wherein a barcode or other optical code is scanned. Scanning automation is readily achieved if all UPCs or other forms of optical, machine-readable representation of data to be scanned are on articles of the same size, shape and orientation relative to a scanning device. A conveyor can then move a train of singulated articles into a fixed location for automatic scanning. In general, however, the articles on which optical, machine-readable representations of data are to be scanned will be of arbitrary size and shape, as in typical grocery shopping, complicating process automation.

Other difficulties must be overcome to advance the automatic scanning of optical, machine-readable representations of data displayed on articles of arbitrary size and shape and orientation relative to a data reading device. In general, the representations of data on diverse articles will be of diverse kinds and size standards, even if all the data representations on the articles are UPCs. Even if a UPC on a given article can be read by an available scanning device, it will still take time to locate the UPC and possibly several attempts to put it into a suitable orientation relative to the scanning device for productive reading.

For such reasons and others, it is desirable to develop improved systems and methods for the automated reading of optical, machine-readable representations of data for moving articles of arbitrary size, shape and orientation. Despite advances in this area, further improvements are possible.

### SUMMARY OF THE INVENTION

In view of the foregoing, it is an object of the present disclosure to provide an improved system and related method for automating the reading of optical, machine-readable representations of data on still or moving articles of arbitrary size, shape and orientation. It is assumed that at least one such representation of data will be located on the exterior surface of each article, as is generally the case.

In one aspect of the present invention, the system comprises a detection and imaging zone defined by a predetermined volume and a plurality of proximity sensors configured for detecting the presence of an article at one or more locations in the said zone, independent of the size, shape and orientation of the article. The system does not include the article itself. The plurality of proximity sensors can be configured for triggering one or more functions of high-speed, high-resolution imaging devices.

In another aspect of the present invention, the system comprises a plurality of sets of high-speed, high-resolution imaging devices. These devices can be used to capture one or more images of a detection and imaging zone of a predetermined volume when an article is detected therein by one or more proximity sensors. The plurality of sets of imaging devices are positioned and adjusted so that the optical axis of each such device will pass through, and the focus point of each such device will lie in, the detection and imaging zone, and so that the plurality of sets of imaging devices, when taken together, will enable high-speed, high-resolution imaging of optical, machine-readable representations of data throughout the volume of the detection and imaging zone. The imaging devices can also send the captured images to a processor.

In yet another aspect of the present invention, the system further comprises a processor configured to receive image data from one or more high-speed, high-resolution imaging devices and convert into data of a specified format at least one image of an optical, machine-readable representation of data on the exterior surface of an article detected by one or more proximity sensors in a detection and imaging zone.

According to one embodiment of the present invention, a method for the automatic reading of an optical, machine-readable representation of data on an article of arbitrary size, shape and orientation includes one or more of a plurality of proximity sensors detecting the article in a detection and imaging zone of a predetermined volume. Such detection by a first proximity sensor triggers a first imaging device of a respective set of high-speed, high-resolution imaging devices and, in turn, any remaining imaging devices of the same set. The remaining sets of imaging devices are then triggered in succession as the respective proximity sensors detect the article moving in the detection and imaging zone. The triggering of the plurality of sets of imaging devices enables the capture of one or more images of the article in the detection and imaging zone. The one or more such images are transferred to a processor, optical, machine-readable representations of data are identified in the images, and the representations of data are converted to data of a specified format.

These and other objects, aspects and advantages of the present invention will be better appreciated in view of the drawings and following detailed description of preferred embodiments.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a representative depiction of one embodiment of the present invention, a system for automatic reading of optical, machine-readable representations of data;

FIG. 2 shows a representative coupling of various electronic devices of the present system for automatic reading of optical, machine-readable representations of data;

FIG. 3 depicts a representative embodiment of the present invention in which a detection and imaging zone, proximity sensors and imaging devices are viewed from a side of a conveyor;

FIG. 4 depicts a representative embodiment of the present invention in which a detection and imaging zone, proximity sensors and imaging devices are viewed from above a conveyor; and

FIG. 5 is a flowchart of a method for automatic reading an optical, machine-readable representation of data on an article.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

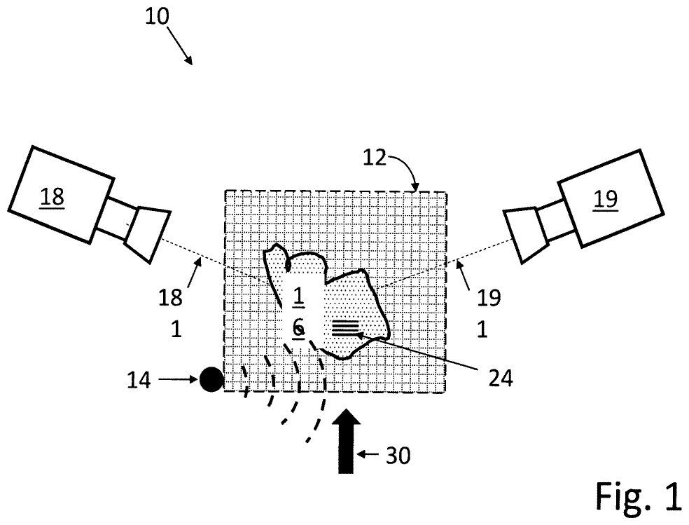

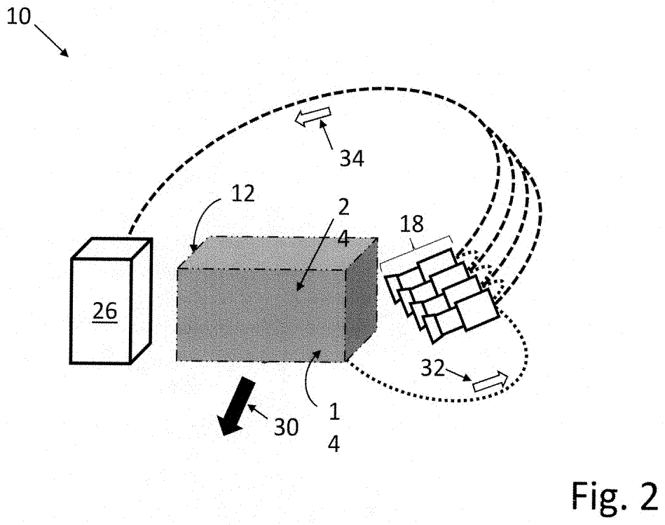

Referring to FIGS. 1 and 2, according to one embodiment of the present invention, a system 10 for the automatic reading of optical, machine-readable representations of data includes: a detection and imaging zone 12, a cuboid of specified volume; a plurality of proximity sensors 14 configured to detect the presence of an article 16 within the detection and imaging zone 12; the plurality of proximity sensors 14 being further configured to communicate with a plurality of sets of high-speed, high-resolution imaging devices (e.g. sets 18 and 19) via respective electrical connections 32; each device of the plurality of sets of imaging devices being configured to capture one or more images of the detection and imaging zone 12 when an article 16 is detected therein by one or more of the plurality of proximity sensors 14; the article 16 having a machine-readable representation of data 24 on its exterior surface; each device of the plurality of sets of imaging devices (e.g. sets 18 and 19) being further configured to send at least one captured image of the detection and imaging zone 12 to a processor 26; the processor 26 being configured to communicate with the plurality of sets of imaging devices (e.g. sets 18 and 19) via respective electrical connections 34 and to process each image received from each device of the plurality of sets of imaging devices by enhancing contrast, identifying one or more optical, machine-readable representations of data, and converting images of representations of data into data of a specified format, for example, strings of alphanumeric characters.

The article 16 can be of arbitrary size, shape and orientation, as shown in FIG. 1. The system 10 can identify the article 16 when just an optical, machine-readable representation of data 24 on the exterior surface of the article 16 is in or passes through the detection and imaging zone 12, or when the entire volume of the article 16 is in or passes through the detection and imaging zone 12. The detection and imaging zone 12 can be of any size or shape suited for the purpose. For simplicity, the detection and imaging zone 12 can be cuboidal and therefore hexahedral, as shown in the embodiment of the present invention in FIG. 2. This shape is convenient for defining a side of the detection and imaging zone 12 as an entrance side for the article 16, the interior as the middle portion of the detection and imaging zone 12, and a side of the detection and imaging zone 12 as an exit side for the article 16. The volume of the detection and imaging zone 12 can be chosen to accommodate a spectrum of possible sizes, shapes and orientations of the article 16 for reliable automatic reading of the optical, machine-readable representation of data 24 displayed thereon and other possibly relevant considerations, for instance, conveyor size standards. The plurality of proximity sensors 14, the plurality of sets of high-speed, high-resolution imaging devices (e.g. sets 18 and 19) and the processor 26 can be electrically coupled by wires, as illustrated in FIG. 2, or by any convenient wireless communication method.

The plurality of proximity sensors 14 can be positioned outside but close to the various faces of the detection and imaging zone 12 and configured to detect an article (e.g. article 16) therein. Each of the plurality of proximity sensors 14 can detect an article (e.g. article 16) by any convenient physical principle or observable quantity (e.g. light, ultrasound or weight). In an embodiment of the present invention, at least one of the plurality of proximity sensors 14 is an electromagnetic sensor configured to detect the presence of an article (e.g. article 16) in the detection and imaging zone 12 upon a change in a reflected electromagnetic signal. In this case, an electromagnetic signal emitted by a proximity sensor 14 is reflected and received by the same sensor 14 when no article is present but not received by the same sensor 14 when an article (e.g. article 16) is present in the respective region of the detection and imaging zone 12.

Each of the plurality of proximity sensors 14, regardless of type, can be in electrical communication with a first device in one or more respective sets of a plurality of sets of high-speed, high-resolution imaging devices (e.g. sets 18 or 19). This will enable the triggering of device function upon detection of an article (e.g. article 16) in the detection and imaging zone 12. The triggering of a first imaging device of a set of imaging devices (e.g. set 18 or 19) will precede or effectively coincide with the triggering of the remaining imaging devices in the same set of imaging devices.

The plurality of sets of high-speed, high-resolution imaging devices (e.g. sets 18 and 19) can be configured in diverse ways as regards location and attitude. In one embodiment of the present invention, each of the sets of imaging devices (e.g. set 18 or 19) is positioned outside but close to the various faces of the detection and imaging zone 12 at diverse locations in space. This will avoid any of the plurality of sets of imaging devices (e.g. set 18 or 19) interfering with the motion of an article (e.g. article 16) in the detection and imaging zone 12 and enable imaging of the detection and imaging zone 12 from diverse perspectives when an article (e.g. article 16) is detected therein.

Each device of the plurality of sets of high-speed, high-resolution imaging devices (e.g. sets 18 and 19) will have a respective optical axis (e.g. axes 181 and 191). Each such device can be configured for its optical axis to pass through a detection and imaging zone 12. Each such device can further be configured for its focus point, which will lie within the respective depth of field of the device, to have a unique set of spatial coordinates in the detection and imaging zone 12. This can ensure that at least one of the images captured by the plurality of imaging devices of the detection and imaging zone 12 will contain an optical, machine-readable representation of data 24 on the article 16 in focus and at sufficient resolution for accurate reading and conversion to a desired data format.

In an embodiment of the present invention, each set of the plurality of imaging devices (e.g. set 18 or 19) comprises one or more cameras. Each camera captures high-resolution (e.g. 24-megabyte) images at high-speed (e.g. 32 frames per second). The spatial coordinates of the focus point of each such camera lie within a detection and imaging zone 12. The one or more cameras of each set of imaging devices have non-parallel optical axes, perpendicular to the direction of motion 30 of the article 16 in the detection and imaging zone 12. In another embodiment, the optical axes of the imaging devices of each set of imaging devices (e.g. set 18 or 19) are parallel to each other, and no optical axis is perpendicular to the direction of motion 30.

A plurality of proximity sensors 14 and a plurality of sets of imaging devices (e.g. sets 18 and 19) are positioned to one or both sides of a detection and imaging zone 12, before and/or behind the detection and imaging zone 12, and above and/or below the detection and imaging zone 12 with respect to the motion of an article 16 in the detection and imaging zone 12 and the orientation of the sides of the detection and imaging zone 12, as illustrated by the direction of motion 30 of the article 16 in FIGS. 1 and 2 and the orientation of the detection and imaging zone 12 in FIG. 2.

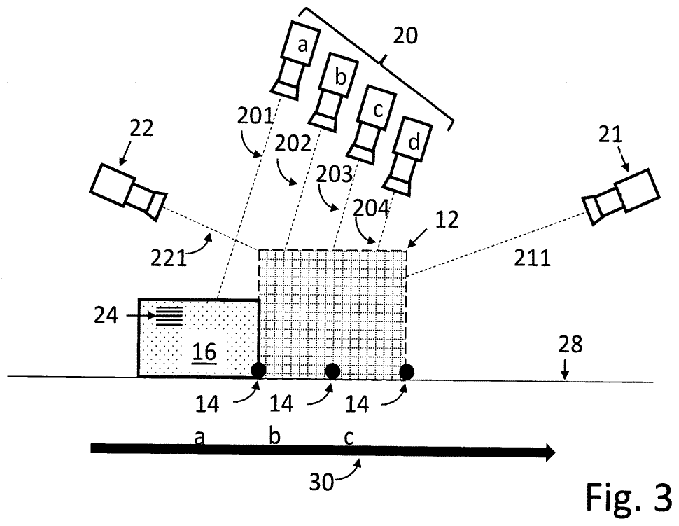

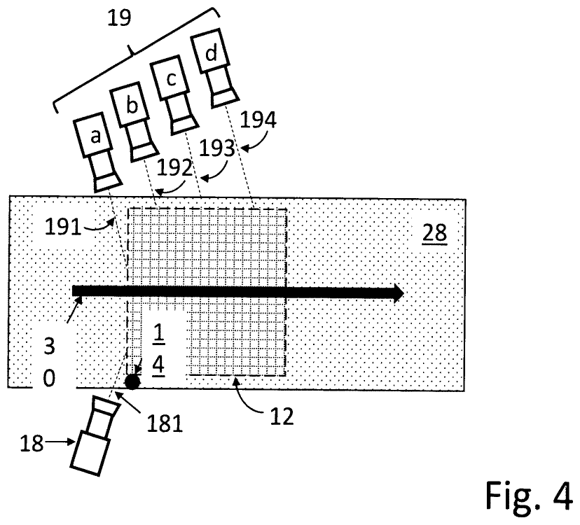

Referring now to FIGS. 3 and 4, which present an embodiment of a system 10, a conveyor 28 in is continuous motion in a direction 30. The plane of the conveyor 28, which is viewed edge-on, coincides with the plane of a face of a cuboidal detection and imaging zone 12. The entire volume of an article 16, depicted at rest on the conveyor 28, can pass through the detection and imaging zone 12. The exterior surface of the article 16 features an optical, machine-readable representation of data 24. As time proceeds, the article 16 will enter and eventually leave the detection and imaging zone 12.

Three sets of high-speed, high-resolution imaging devices (sets 20, 21 and 22) are shown in FIG. 3. Set of imaging devices 20 (devices 20a-d) is situated “above” the detection and imaging zone 12; and sets of imaging devices 21 and 22 are respectively situated “before” and “behind” the detection and imaging zone 12. These sets of imaging devices are triggered by a plurality of proximity sensors 14, respectively, sensors 14a, 14b and 14c. In an embodiment of the present invention sensors 14a-c respectively define an entrance side, a middle portion and an exit side of the detection and imaging zone 12. The temporal order of triggering of the plurality of proximity sensors 14 will be determined by the motion of an article 16 through the detection and imaging zone 12, the order in which the proximity sensors 14a-14c detect the article 16, and the protocol used to enable the proximity sensors 14a-14c to communicate with the sets of imaging devices 20-22. All the respective optical axes 201-204, 211 or 221 pass through the detection and imaging zone 12, and each device in the sets of imaging devices 20-22 can capture images of the detection and imaging zone 12. In the configuration shown, however, none of the captured images will contain an image of an optical, machine-readable representation of data on the exterior surface of the article 16, unless the optical, machine-readable representation of data 24 is on a side of the exterior surface of the article 16. This is because the sets of imaging devices 20, 21 and 22 are situated “above,” “before” and “behind” the detection and imaging zone 12. Therefore, if the optical, machine-readable representation of data 24 is on a side of the article 16, at least one more set of imaging devices will be needed to capture at least one image of the representation of data 24 as the article 16 passes through the detection and imaging zone 12.

Turning to FIG. 4, the conveyor 28 shown in FIG. 3 is viewed from above. According to an embodiment of the present invention, a proximity sensor 14 on one side of the detection and imaging zone 12 can trigger two sets of high-speed, high-resolution imaging devices 18 and 19; the set 18 on a first side and the set 19 on a second side of the detection and imaging zone 12. Both the article 16 and the detection and imaging zone 12 are present in FIG. 4 as shown in FIG. 3, but for clarity neither is shown in FIG. 4. There is an optical, machine-readable representation of data 24 on a side of the exterior surface of the article 16. None of the imaging devices 19a-d will be able to image the representation of data 24, because it is on the opposite side of the article 16 from the set of imaging devices 19. By contrast, at least one device of the set of imaging devices 18 will be able to image the representation of data 24 during image capture of the detection and imaging zone 12, because the representation of data 24 is on the same side of the exterior surface of the article 16 as the set of imaging devices 18.

A plurality of proximity sensors 14 (e.g. sensors 14a-d) of a system 10 can be positioned relative to a detection and imaging zone 12 and so enable the repeated detection of an article 16 in the detection and imaging zone 12. The plurality of proximity sensors 14 can communicate electronically with a respective plurality of sets of imaging devices (e.g. sets 18 and 19), enabling successive triggering of the sets of imaging devices. The one or more imaging devices of each set of imaging devices can be configured for sequential image capture. The plurality of sets of imaging devices can thus provide repeated image capture of different views of the detection and imaging zone 12 at different time points. One or more of these images will contain an image of the article 16 and of an optical, machine-readable representation of data 24 on the exterior surface of the article 16. The representation of data 24 can be a UPC, a QR code, another one-dimensional code or two-dimensional code, text, pictograms or the like. Each imaging device of the plurality of sets of imaging devices can send at least one image thus captured to a processor 26.

The processor 26 can be configured for real-time image processing and storage. The processor 26 can further be configured to execute, for each image received from a high-speed, high-resolution imaging device, an enhancement process to accentuate high-contrast edges, for example, regions of “white” pixels in close proximity to regions “black” pixels. The processor 26 can further be configured to execute a process to identify an optical, machine-readable representation of data in each image received and, for each representation of data identified, execute a process to convert the representation of data, for example a UPC, into data of a specified format, for example, a corresponding string of characters. The characters can be letters, numerals or related characters in the International Organization for Standardization/International Electrotechnical Committee (ISO/IEC) 10646 standard, which specifies the universal character set, or a similar standard. The processor 26 can be further configured to execute processes to store the received image data, the enhanced image data, the optical, machine-readable representation of data identified, and/or the image data converted to data of a specified format.

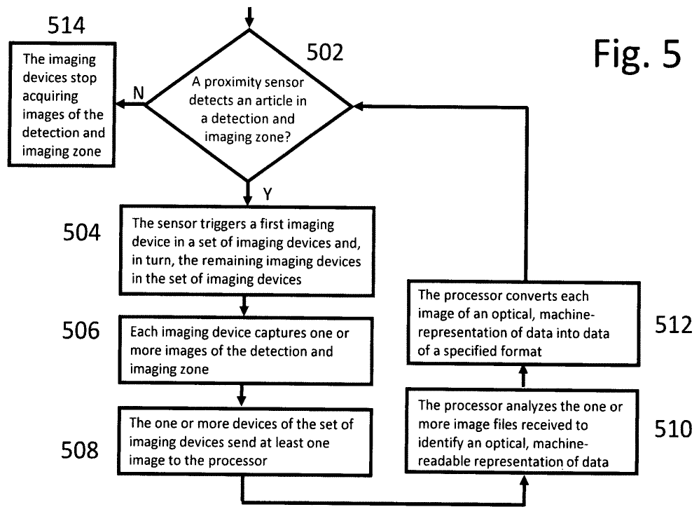

Referring specifically to FIG. 5 and generally to FIGS. 2 and 4, in an embodiment of the present invention a system 10 reads an optical, machine-readable representation of data 24 on a first article 16 at step 502 of a method that includes detecting the article 16 in the detection and imaging zone 12 by a first proximity sensor 14a and converting the read data to data of a specified format. The article is of arbitrary size, shape and orientation. The nature of detection will depend on the one or more proximity sensors 14 comprised by the system 10. The first proximity sensor 14a can be an electromagnetic sensor, for which detection will occur when the article 16 “breaks” the optical path between an electromagnetic wave emitter and a reflector associated with the sensor 14a.

At step 504, the first proximity sensor 14a triggers a first imaging device 18a, and thereafter any other imaging devices in the same set, for example, 18b, 18c and 18d, in a first set 18 of a plurality of sets of high-speed, high-resolution imaging devices of the system 10.

At step 506, the first imaging device 18a in the first set of high-speed, high-resolution imaging devices 18 begins capturing images of the detection and imaging zone 12, and thereafter any other imaging devices in the same set, for example devices 18b-d, begin to do likewise.

At step 508, the one or more high-speed, high-resolution imaging devices of the set of imaging devices 18 send at least one image to the processor 26, typically at a fixed rate.

At step 510, the processor begins executing processes to enhance each image file received from the set 18 of high-speed, high-resolution imaging devices and to identify an optical, machine-readable representation of data 24 therein.

At step 512, the processor begins to execute processes to convert each optical, machine-readable representation of data 24 thus identified into data of a specified format.

The method then makes a first return to step 502, and if a second proximity sensor 14b detects the article 16 in the detection and imagining zone 12, steps 504-512 are repeated, though necessarily for at least one different set of high-speed, high-resolution imaging devices from the previous iteration, for example, devices 19a, 19b, 19c and 19d of set 19, but generally for the same processor 26 for all aspects of image processing not executed by the imaging devices themselves. Steps 504-512 are repeated for as many times as there are proximity sensors 14. For example, if the system 10 comprises four proximity sensors 14a-d, steps 504-512 will be executed four times. One or more sets of imaging devices can be triggered by the detection of an article (e.g. article 16) by a single proximity sensor.

At step 514, the article 16 leaves the detection and imaging zone 12 and the method terminates. Imaging of the detection and imaging zone 12 when the first article 16 is detected within by the plurality of proximity sensors 14 is completed, and image transfer, analysis and data conversion will conclude after a time interval determined by the rates of these processes. The system 10 is now ready for a second article 16 to be detected by one or more of the plurality of proximity sensors 14 in the detection and imaging zone 12 at step 502.

As utilized herein, ‘arbitrary orientation’ means “any attitude of an article relative to an interrogation device used to image an optical, machine-readable representation of data on the exterior surface of the article.” The article can be a box, flat, softpack or other type of item (see FIG. 1, article 16). This implies that an optical, machine-readable representation of data on the exterior surface of the article can have an arbitrary orientation with respect to the imaging devices used to image the representation of data.

‘Arbitrary shape and size’ means “any volume of any shape, provided that it is at once large enough to accommodate the entire area of a label on which a complete, standard-sized optical, machine-readable representation of data can be printed and small enough for a portion of an article on which an optical, machine-readable representation of data is displayed to pass through a detection and imaging zone.”

‘Article’ means “a member of a class of things,” and more specifically, “a thing, often an item of merchandise, the exterior surface of which can display an optical, machine-readable representation of data.”

‘Depth of field’ means “the distance between the nearest and the farthest objects to an optical imaging device that give an image judged to be in focus in images captured by the imaging device.”

‘Detection and imaging zone’ means “a volume of space, for example that defined by the surface of a cuboid, wherein the presence of an article of arbitrary size and shape can be detected and an image of an optical, machine-readable representation of data on the article can be captured at high resolution.”

‘Focus point’ means “the point within in the field of view, in the depth of field and on the optical axis of an imaging device for which a focused image can be formed by the imaging device.” In fact, a lens will have a set of focus points, or focus surface, corresponding not only to one point on the optical axis but also to points off the axis. In some situations, the focus surface is effectively a volume, for example when the depth of field of a camera is wide, depending on the properties of the imaging device. The properties of imaging devices noted here can be useful for effective imaging of the entire volume of a detection and imaging zone, for example, the detection and imaging zone 12 in FIG. 1.

‘High-resolution camera’ means “an optical interrogation device that can capture frames of sufficient resolution for imaging and accurate reading of one or more optical, machine-readable representations of data.”

‘High-speed camera’ means “an optical interrogation device that can capture and transfer at least one high-resolution frame in a time interval corresponding to the motion of an article in a detection and imaging zone.” The motion of the article can be determined by the speed of a conveyor used to bring the article to and transport it through the detection and imaging zone.

‘Interrogation device’ means “an electronic instrument that provides a specific type of information, for example, an information retrieval system that displays data upon inquiry.” An interrogation device can be a high-speed, high-resolution camera that, when triggered, captures one or more images of an article in a detection and imaging zone.

‘Moving article’ means “an article in motion relative to a frame of reference in which interrogation devices and proximity sensors are at rest.” The article will be at rest relative to a reference frame that moves with the article.

‘Optical axis’ means “an imaginary straight line passing through the geometrical center of a lens and joining the centers of curvature of its surfaces.” A synonym of ‘optical axis’ is ‘principal axis’. Roughly speaking, the optical axis defines the path along which light propagates in an optical system.

‘Optical, machine-readable representation of data’ means “encoded information that can be read by a device that utilizes electromagnetic radiation in the visible range, near-UV range or near-IR range in the reading process.” The representation of data can be printed on a label attached to an article or screened, etched, peened or otherwise formed on a manufactured article. Numerous examples of such representations of data are noted herein.

‘Processor’ means “one or more components in a computer responsible for receiving input data, executing the instructions of one or more computer programs by performing basic arithmetic logical, control and input/output operations specified by the instructions, and carrying out related functions.”

‘Proximity sensor’ means “a device that can detect the presence of a nearby article, often within 10 meters of the device.” The proximity sensor of the present machine vision method can be an electromagnetic sensor that operates in the IR or another kind of proximity sensor, for example, an ultrasound sensor or a weight sensor.

‘Scan’ means “to use a device to read an optical, machine-readable representations of data.” A scan is productive if it results in an accurate reading of an optical, machine-readable representations of data.

‘Singulated’ means “separated into individual articles.” Singulation precludes exceptional situations in which a second article shadows or otherwise blocks one or more sides of a first article in the detection and imaging zone.

‘Surface of an article’ means, in general, “the exterior surface of the article, regardless of the number of sides or faces.” For example, a cube has six faces or sides but only one surface. If the cube is a solid, it will have an exterior surface.

‘Symbology’ means “the study or use of symbols, for example, machine-readable representations of data.” An example of a symbology is the UPC.

A UPC is a kind of barcode, a kind of machine-readable representation of data, or symbology, and more specifically, a discrete symbology. Barcode data are typically encoded in the width and spacing of a plurality of (light-absorbing) black lines on a (light-reflecting) white field. A line is a one-dimensional figure. The lines are elongated to increase the odds of accurate reading. Two-dimensional barcodes are known, as are similar codes involving rectangles, dots, hexagons or other geometric shapes. Important here, the principles whereby practical use is made of these codes are essentially the same as for UPCs.

In view of the foregoing, the kinds of optical, machine-readable representations of data that can be read by a system 10 of the present invention can be a UPC, any other type of barcode, a QR code, an Australian Post code, an Aztec code, a BPO code, a Canada Post code, a Codabar, a Codablock, a Code 11, a Code 39, a MSI Code, a PDF417, a Planet code, a Plessey code, a Postnet, a reverse logistics (RL) labeling code, a RSS, a Standard 2 of 5, a Telepen, a TLC 39, or any other optical, machine-readable, one- or two-dimensional representation of data for which practical use is essentially the same as for UPCs.

Moreover, text itself can be considered a type of optical, machine-readable representation of data, regardless of alphabet, script or font. This is because text can be read by optical character recognition (OCR) for a great variety of alphabets, scripts and fonts, for example, the characters in the ISO/IEC 10646 standard or a similar standard. Furthermore, the present system and method are not restricted to an alphabetic script, because reliable means exist for the OCR of pictograms, for example, simplified or traditional Chinese characters.

Diverse methods of reading optical, machine-readable representations of data and related devices are known in the art. Devices for UPC reading, for example, include pen-type scanners, laser scanners, charge-coupled device readers (or light-emitting diode scanners), video camera readers, large field-of-view readers, omnidirectional barcode scanners, and cell phone cameras. Certain general principles apply to all these cases, because all read a barcode by distinguishing between white lines and black lines and line width.

In the case of a typical optical barcode scanning device, a sensor of the device detects reflected light from the barcode and generates an analog signal. The electrical potential of the signal corresponds to the reflected light intensity, low intensity for a bar (black) and high intensity for a space between two bars (white). An electrical device then converts the analog signal to a digital form. The digital signal is decoded, and the decoded signal is validated by a check digit in the UPC and converted into standard characters, often a string of alphanumeric characters. These characters constitute the decoded data set.

In the case of a typical smartphone scanner, an application on a mobile device converts a digital image of a barcode into a corresponding string of characters. “White” pixels in the image correspond to one of the two levels of electrical potential in optical scanning, and “black” pixels correspond to the other level of electrical potential. The resolution of the imaging device must be high enough to provide an accurate representation of the widths of lines and spaces between lines.

The data encoded in a typical optical, machine-readable representation generally concern the article on which the representation is affixed. A UPC, for example, can be attached to a corresponding article by means of a printed and/or adhesive label. A printed UPC can be generated on demand and prepared with any convenient device.

Uses of UPCs and other optical, machine-readable representations of data include customer identification, lending library book identification, luggage identification and tracking, patient identification and tracking, and medication management. UPCs are especially useful for product authenticity verification, identification, inventory and tracking. The present system and method are potentially suitable for a variety of different applications, for example, point-of-sale inventory management, factory floor management and parcel sorting.

A virtue of the present system and method is that they can potentially be utilized in isolation, for instance, when the goal is to ascertain the identity of an article, or in association with related systems and methods, for example, a system that can automatically determine the height of the article, a system that can automatically apply a label to the article, and/or a system that can automatically decide the disposition of the article based on its identity and condition, current demand, etc.

Many additional modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within.

The foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described.

What is claimed is:

1. A system for the automatic reading of an optical, machine-readable representation of data on the exterior surface of an article, the system comprising:
a detection and imaging zone defined by a predetermined volume;
a plurality of proximity sensors configured for detecting the presence of the article in the detection and imaging zone;
a plurality of sets of high-speed, high-resolution imaging devices configured for capturing one or more images of the detection and imaging zone upon detection of the article by one or more of the plurality of proximity sensors; and
a processor configured for:
receiving the one or more images of the detection and imaging zone from the plurality of sets of imaging devices;
identifying one or more representations of data in the one or more images; and
converting one or more of the identified images of representations of data into data of a specified format;
wherein each of the plurality of proximity sensors is configured for detecting the article independent of the other proximity sensors and triggering image capture by one or more imaging devices in one or more of the plurality of sets of imaging devices; and
wherein each imaging device of the plurality of sets of imaging devices is configured for having its optical axis pass through the detection and imaging zone and its focus point lie within the detection and imaging zone.

2. The system of claim 1, wherein the detection and imaging zone is cuboidal in shape and so has six sides.

3. The system of claim 1, wherein the plurality of proximity sensors are one or more of an electromagnetic sensor, an ultrasonic sensor, a weight sensor, a thermal sensor or a combination thereof.

4. The system of claim 1, wherein the plurality of sets of high-speed, high-resolution imaging devices are located at one or more of above, beneath, before, behind, to the left side or to the right side of the detection and imaging zone.

5. The system of claim 1, wherein each imaging device in a set of the plurality of sets of high-speed, high-resolution imaging devices is configured to capture images of the detection and imaging zone sequentially in time at a specified frame rate.

6. The system of claim 1, wherein at least two of the high-speed, high-resolution imaging devices of a set of such devices are configured to have parallel optical axes.

7. The system of claim 1, wherein one or more of the high-speed, high-resolution imaging devices has image data storage capacity.

8. The system of claim 1, wherein the system further includes one or more image processors incorporated into one or more imaging devices of the plurality of sets of high-speed, high-resolution imaging devices, and wherein the image processors are configured for one or more of enhancing contrast, identifying optical, machine-readable representations of data, and converting the images of the representations of data into data of a specified format.

9. The system of claim 1, wherein each imaging device of the plurality of sets of high-speed, high-resolution imaging devices is configured to capture a predetermined number of images of the detection and imaging zone when triggered by a proximity sensor.

10. The system of claim 1, wherein each imaging device of the plurality of sets of high-speed, high-resolution imaging devices is configured to capture images of the detection and imaging zone at a predetermined rate when triggered by a proximity sensor.

11. The system of claim 1, wherein the one or more optical, machine-readable representations of data on the exterior surface of the article includes one or more of a one-dimensional code and a two-dimensional code.

12. The system of claim 1, wherein the one or more optical, machine-readable representations of data on the exterior surface of the article includes one or more of a UPC and a QR code.

13. The system of claim 1, wherein the one or more optical, machine-readable representation of data on the exterior surface of the article includes one or more pictograms or characters in the ISO/IEC 10646 standard.

14. The system of claim 1, wherein the specified data format includes a string of digits, a string of alphabetic characters, a combination thereof, alphabetic representations of pictograms, or characters in the ISO/IEC 10646 standard.

15. The system of claim 1, wherein the processor is configured to convert images of optical, machine-readable representations of data into data of a specified format.

16. The system of claim 1, wherein the connections between the plurality of proximity of sensors, the plurality of sets of high-speed, high-resolution imaging devices and the processor are wired connections, wireless connections, or a combination thereof.

17. A system for the automatic reading of optical, machine-readable representations of data on the exterior surface of an article on a moving conveyor, the system comprising:
a cuboidal detection and imaging zone defined by six faces;
a plurality of electromagnetic proximity sensors configured for detecting the presence of the article at an entrance side, in the middle portion and at an exit side of the detection and imaging zone;
a plurality of sets of high-speed, high-resolution cameras configured for capturing one or more images of the detection and imaging zone upon detection of the article by the respective proximity sensors; and
a processor configured for receiving the one or more images of the detection and imaging zone from the imaging devices in the plurality of sets of imaging devices, enhancing the contrast of each image received, identifying an optical, machine-readable representation of data in each image received, and converting each image of a representation of data to data of a specified format;
wherein at least one side of the detection and imaging zone is coplanar with the conveyor;
wherein each of the plurality of proximity sensors is configured for detecting the article independent of the other proximity sensors and triggering image capture by one or more imaging devices in one or more of the plurality of sets of imaging devices;
wherein each imaging device of the plurality of sets of imaging devices is configured for having its optical axis pass through the detection and imaging zone and its focus point lie within the detection and imaging zone;
wherein the specified data format comprises characters in the ISO/IEC 10646 standard.

18. A method of reading an optical, machine-readable representation of data on an article of arbitrary size, shape and orientation as the article moves through a detection and imaging zone, the method comprising:
detecting the presence of the article within the detection and imaging zone by one or more of a plurality of proximity sensors;
triggering a first imaging device of one or more sets of a plurality of sets of high-speed, high-resolution imaging devices to capture one or more images of the detection and imaging zone;
triggering the remaining imaging devices of the one or more sets of the plurality of sets of imaging devices to capture one or more images of the detection and imaging zone in succession;
transferring a plurality of captured images to a processor;
identifying one or more images having a representation of data in the plurality of transferred images; and
converting representations of data in the one or more identified images into data of a specified format.

19. The method of claim 18, wherein the plurality of the proximity sensors comprise one or more of an electromagnetic sensor, an ultrasound sensor, a weight sensor and a thermal sensor.

20. The method of claim 18, wherein the specified data format includes a string of digits, a string of alphabetic characters, a combination thereof, alphabetic representations of pictograms, or characters in the ISO/IEC 10646 standard.
